(19) United States
(12) Patent Application Publication
(10) Pub. No.: US 2015/0170067 A1
(43) Pub. Date: Jun. 18, 2015

(54) DETERMINING ANALYSIS RECOMMENDATIONS BASED ON DATA ANALYSIS CONTEXT

(71) Applicant: International Business Machines Corporation, Armonk, NY (US)

(72) Inventors: Bharath R. Ganesh, Trivandrum (IN); Rajanikant Malviya, Pune (IN)

(73) Assignee: International Business Machines Corporation, Armonk, NY (US)

(21) Appl. No.: 14/109,373

(22) Filed: Dec. 17, 2013

(51) Int. Cl. G06Q 10/06

(52) U.S. Cl. CPC G06Q 10/063

(57) ABSTRACT

Embodiments of the present invention disclose a computer implemented method, computer program product, and system for proposing recommendations in data analysis based on context. In one embodiment, in accordance with the present invention, the computer implemented method includes the steps of determining analytical context of an analysis step currently being performed in a data analysis, identifying a list of previously performed analysis branches that are similar to the determined analytical context, identifying a set of most similar previously performed analysis branches based on a similarity index rating associated with each previously performed analysis branch that is in an analysis tree associated with each previously performed analysis branch in the identified list, and proposing analysis recommendations for the analysis step currently being performed based on analytical context of the previously performed analysis branches in the identified set.

### FIELD OF THE INVENTION

The present invention relates generally to the field of data analysis, and more particularly to determining recommendations in data analysis based on context.

### BACKGROUND

With increasing amounts of available data, data analysis is increasingly important for determining relevant information from a large volume of data. Business analytics makes use of data analysis in an effort to determine important information (e.g., trends) from large volumes of data. Data can be utilized with business analytics for statistical and quantitative analysis, visualization, impact and cause analysis, predictive modeling and other forms of data analysis in accordance with goals of a business.

Business analytics utilizes data from a variety of different domains to derive a visualization that encompasses multiple aspects of the business. For example, data analysis in business analytics can be used to visualize a graphical depiction of sales of different types of products relative to the method with which an order was placed (e.g., online, telephone, in-store). Determining relevant trends in an analysis of data is a multi-step and multi-variable process, which can be accomplished through a variety of different methods. An individual experienced in the business analytics field is more likely to be familiar with methods that can produce insights that correspond to the interests of a business.

### SUMMARY

Embodiments of the present invention disclose a computer implemented method, computer program product, and system for proposing recommendations in data analysis based on context. In one embodiment, in accordance with the present invention, the computer implemented method includes the steps of determining analytical context of an analysis step currently being performed in a data analysis, identifying a list of previously performed analysis branches that are similar to the determined analytical context, wherein an analysis branch is a set of analysis steps that corresponds to attributes of an analytical context, identifying a set of most similar previously performed analysis branches based on a similarity index rating associated with each previously performed analysis branch that is in an analysis tree associated with each previously performed analysis branch in the identified list, wherein an analysis tree is a set of analysis branches that share a common analysis step, and proposing analysis recommendations for the analysis step currently being performed based on analytical context of the previously performed analysis branches in the identified set.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for proposing data analysis recommendations to an individual performing an analysis of data, in accordance with an embodiment of the present invention.

FIG. 3 depicts a block diagram of components of the computing system of FIG. 1 in accordance with an embodiment of the present invention.

### DETAILED DESCRIPTION

Embodiments of the present invention allow for proposing data analysis recommendations to an individual performing an analysis of data, based on the context of the current data analysis step. In one embodiment, a current data analysis step is compared to previous analyses in order to identify previous analyses that are similar to the analytical context of the current data analysis step. For a previous analysis that is determined to be similar to the context of the current data analysis step, related analyses (based off of each similar analysis branch) are recommended to the individual performing the data analysis.

Embodiments of the present invention recognize that as the volume of data increases, data analysis becomes more difficult. For less experienced individuals analyzing a large volume of data, simply presenting a visualization of retrieved data may not provide enough information to determine trends and other information from the data. Providing recommendations of analysis steps to an individual analyzing data can increase the likelihood of determining relevant insights into the data. Individuals analyzing data often start by analyzing data at a high level, and systematically narrow the scope of the analysis through filtering until the desired level of analysis is achieved.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of a computer-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions, which execute on the computer or other programmable apparatus, provide processes for implementing the functions/acts specified in the flowchart and/or block diagram block or blocks.

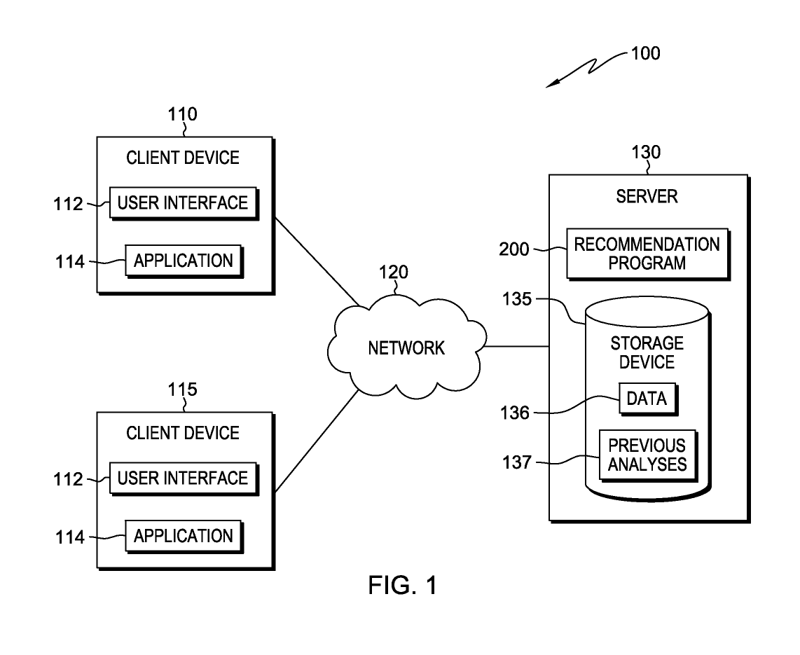

The present invention will now be described in detail with reference to the Figures. FIG. 1 is a functional block diagram illustrating a distributed data processing environment, in accordance with one embodiment of the present invention.

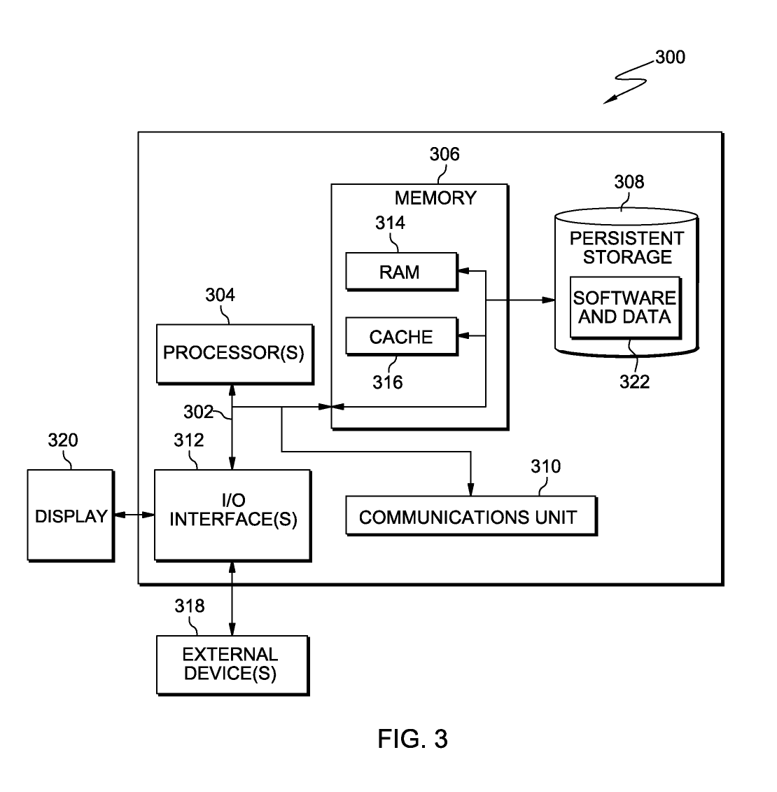

An embodiment of data processing environment 100 includes client device 110 and 115, and server 130, all interconnected over network 120. In various embodiments of the present invention, client devices 110 and 115 may be workstations, personal computers, personal digital assistants, mobile phones, or any other devices capable of executing program instructions in accordance with embodiments of the present invention. In general, client devices 110 and 115 are representative of any electronic device or combination of electronic devices capable of executing machine-readable program instructions, as described in greater detail with regard to FIG. 3, in accordance with embodiments of the present invention. Client devices 110 and 115 can access data on server 130 through network 120.

Client devices 110 and 115 include respective instances of user interface 112 and application 114. User interface 112 accepts input from individuals utilizing client devices 110 and 115. In example embodiments, application 114 on client devices 110 and 115 analyzes data stored on server 130. For example, application 114 accesses data on server 130 corresponding to sales of different types of products, and creates a visualization (e.g., table, graphical depiction, etc.) of the sales of different types of products relative to the time period of the sale (e.g., year, quarter, etc.). In example embodiments, application 114 receives input from user interface 112, which may be provided by an individual utilizing client device 110 or 115.

In one embodiment, client devices 110 and 115, and server 130 communicate through network 120. Network 120 can be, for example, a local area network (LAN), a telecommunications network, a wide area network (WAN) such as the Internet, or a combination of the three, and include wired, wireless, or fiber optic connections. In general, network 120 can be any combination of connections and protocols that will support communications between client devices 110 and 115, and server 130 in accordance with embodiments of the present invention.

In example embodiments, server 130 can be a desktop computer, computer server, or any other computer system known in the art. In certain embodiments, server 130 represents computer systems utilizing clustered computers and components (e.g., database server computers, application server computers, etc.) that act as a single pool of seamless resources when accessed by elements of data processing environment 100 (e.g., client devices 110 and 115). In general, server 130 is representative of any electronic device or combination of electronic devices capable of executing machine-readable program instructions, as described in greater detail with regard to FIG. 3, in accordance with embodiments of the present invention.

Server 130 includes storage device 135, and recommendation program 200. In example embodiments, storage device 135 stores data that client devices 110 and 115 can access and analyze utilizing application 114. Storage device 135 can be implemented with any type of storage device, for example, persistent storage 308, which is capable of storing data that may be accessed and utilized by client devices 110 and 115, and server 130 such as a database server, a hard disk drive, or flash memory. In other embodiments, storage device 135 can represent multiple storage devices within server 130. In example embodiments, recommendation program 200 provides recommendations in a data analysis corresponding to context of a current data analysis step, in accordance with embodiments of the present invention.

In one embodiment, storage device 135 includes data 136, and previous analyses 137. Data 136 can be any type of data that application 114 can access and analyze (e.g., sales data, financial data, resource utilization, and other forms of data). For example, data 136 includes sales data of different types of products, wherein the sales data includes an amount of each product sold, price of each sale, method with which an order was placed (e.g., online, telephone, in-store), time sold, and other data corresponding to the sale of products. Previous analyses 137 includes data from previous analyses of data 136. For example, data 136 may have been analyzed multiple times by application 114; utilizing differing analysis trails to analyze different sets of data. In one embodiment, previous analyses 137 includes previous visualizations determined from business data 136, and the data that is associated with the visualizations. Previous analyses 137 includes data necessary to recreate analysis states (i.e. steps in data analyses) that have been previously reached, and an instance of previous analyses 137 exists corresponding to each previous data analysis step that has been performed.

Each analysis step that is taken to analyze data 136 (e.g., by an individual utilizing client devices 110 or 115) is stored as an instance of previous analyses 137 in storage device 135 at the time that the data analysis step is performed. In another embodiment, when a previous analysis step is stored as an instance of previous analyses 137 in storage device 135, an indication of analytical context is stored associated with the corresponding instance of previous analyses 137. An analytical context is a set of attributes that characterizes an analysis, and a premise of the data analysis. Attributes included in the determination of analytical context include, but are not limited to name, annotations, data source, concepts, measurements, hierarchies, filters, members, and other parameters in an analysis of data. In one embodiment, annotators (e.g., Unstructured Information Management Architecture (UIMA) annotators) operating concurrently with a data analysis can capture information on attributes associated with the data analysis (e.g., context attributes, intent of the analysis, data trends, etc.). For example, client device 115 is utilizing application 114 to analyze population details of a city. The determined context can contain attributes and concepts including the city, state, country, date, month, year, etc.

In another embodiment, when a previous analysis step is stored as an instance of previous analyses 137 in storage device 135, an associated similarity matrix and similarity index rating is determined and stored. In one embodiment, a similarity index rating is calculated based on relative distance, in a multi vector space (i.e., the similarity matrix), from a given analysis branch to other analysis branches within the same analysis tree. An analysis tree is a set of analysis branches that share a common analysis step (i.e., the root of the analysis tree). An analysis branch is a set of analysis steps that correspond to attributes of an analysis context. In an example embodiment, an analysis branch includes a series of data analysis steps that are performed by application 114 on a set of data in data 136, and is stored in previous analyses 137. In this example, an analysis tree includes all analysis branches that are associated with the first analysis step of the series of data analysis steps.

The multi vector space (i.e., similarity matrix) can be a collection of the context attributes that are utilized to define the context of analysis branches (e.g., a context parameter, a concept, a value, etc.). The similarity index rating can be computed utilizing a distance computing algorithm (e.g., Euclidean Distance Formula) to determine relative distance between analysis branches within the similarity matrix. Each analysis tree had a corresponding similarity matrix that can be utilized to determine similarity index ratings of analysis branches relative to a given analysis branch. For example, a calculation of a similarity index rating can include a distance vector with attributes such as weighted contributions for each context attribute, a number of matching context attributes or parameters, matching ranges, and other parameters of data analysis that can be shared between analysis branches. In example embodiments, the similarity index rating includes a numerical value that provides an indication of the degree in which analysis branches are related to other analysis branches within the same analysis tree (e.g., analysis branches with a higher similarity index rating are more similar than analysis branches with low similarity index ratings).

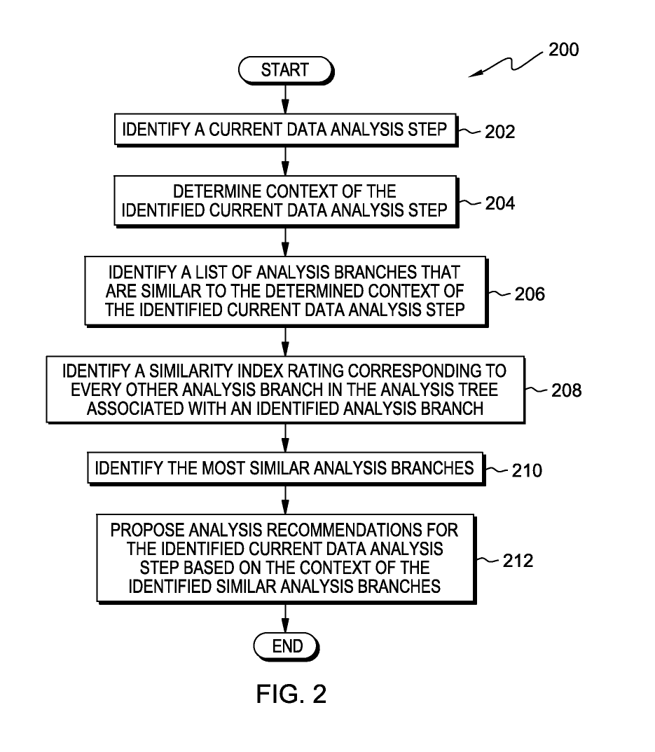

FIG. 2 is a flowchart depicting operational steps of recommendation program 200 in accordance with an embodiment of the present invention. In one embodiment, recommendation program 200 initiates responsive to application 114 initiating a data analysis, or responsive to an application performing an action (e.g., a data analysis step) in a data analysis. For example, recommendation program 200 initiates responsive to application 114 requesting an analysis of data 136, and responsive to application 114 specifying new analysis parameters while analyzing data 136.

In step 202, recommendation program 200 identifies a current data analysis step. In one embodiment, recommendation program 200 identifies the data analysis step (i.e., analysis state) that application 114 is currently performing. For example, the current data analysis step is a graphical depiction responsive to parameters defined through input to application 114 via user interface 112. In an example, an individual is utilizing application 114 on client device 110 to perform a data analysis of data 136 on server 130. In this example, application 114 is performing an analysis of sales data corresponding to product X in North America for a date range of March 2012 to June 2012 that shows a sharp decline. Recommendation program 200 identifies a current data analysis step of application 114 to be “sales data for product X in North America for the date range of March 2012 to June 2012 showing a sharp decline.”

In step 204, recommendation program 200 determines context of the identified current data analysis step. The context of a data analysis step is the set of attributes that characterizes the analysis step, and the premise of the data analysis step. In one embodiment, recommendation program 200 determines the context of the data analysis step that application 114 is currently performing (identified in step 202). In an example embodiment, recommendation program 200 utilizes annotators (e.g., UIMA annotators) to capture information on attributes associated with the identified current data analysis step (e.g., context attributes, intent of the analysis, data trends, etc.). In the previously discussed example, recommendation program 200 identifies the current data analysis step of application 114 to be “sales data for product X in North America for the date range of March 2012 to June 2012 showing a sharp decline” (in step 202). In this example, recommendation program 200 determines and defines the context to be “product X, sales, North America, March 2012 to June 2012, sharp decline.”

In step 206, recommendation program 200 identifies a list of analysis branches that are similar to the determined context of the identified current data analysis step. In one embodiment, recommendation program 200 utilizes the determined context (from step 204) to identify a list of analysis branches, in previous analyses 137, that are similar to the context of the identified current data analysis step. An analysis branch is a set of analysis steps that correspond to attributes of an analysis context. In an example embodiment, an analysis branch includes a series of data analysis steps that are performed by application 114 on a set of data in data 136, and is stored in previous analyses 137. In one embodiment, recommendation program 200 utilizes semantic similarity between the determined context of the current data analysis step and analysis branches of previous analyses 137 to identify the list of similar analysis branches. In the previously discussed example, recommendation program 200 determines the context to be “product X, sales, North America, March 2012 to June 2012, sharp decline” (step 204). In this example, recommendation program 200 identifies a list of analysis branches, which includes an analysis branch of “returns data for product Y in North America for the date range of January 2012 to March 2012 showing a sharp decline,” among a plurality of other analysis branches.

In step 208, recommendation program 200 identifies a similarity index rating corresponding to every other analysis branch in the analysis tree associated with an identified analysis branch. In one embodiment, for each analysis branch in the identified list of analysis branches (from step 206), recommendation program 200 identifies the corresponding analysis tree, and a similarity index rating for every other analysis branch within that analysis tree. An analysis tree is a set of analysis branches that share a common analysis step (i.e., the root of the analysis tree). Each analysis branch stored in previous analyses 137 has an associated similarity matrix, which was determined at the time that the analysis branch was stored in storage device 135. The similarity index rating is stored in storage device 135 in association with the analysis tree and can be utilized to determine similarity index ratings for the analysis branches within the analysis tree.

In step 210, recommendation program 200 identifies the most similar analysis branches. In one embodiment, recommendation program 200 utilizes the identified similarity matrix and similarity index ratings (identified in step 208) to identify analysis branches that have similarity index ratings that indicate high similarity. For example, analysis branches with a higher similarity index rating are more similar than analysis branches with low similarity index ratings. In an example embodiment, the identified most similar analysis branches comprise a list that includes the analysis branches that are in the analysis tree of each of the identified analysis branches (of step 206), and the corresponding similarity index ratings. In various embodiments, the number of analysis branches that recommendation program 200 identifies as most similar can be based on a user defined configuration (e.g., a limit on the number of similar branches, branches within a certain similarity index rating range, etc.). An example of a user defined condition can be a maximum number of 5 similar branches, or branches with a similarity index rating between 0.8 and 1.

In step 212, recommendation program 200 proposes analysis recommendations for the identified current data analysis step based on the context of the identified similar analysis branches. In one embodiment, recommendation program 200 provides the recommendations to application 114 on the client device that is performing the data analysis (i.e. client device 110 or 115). Recommendation program 200, for each identified most similar analysis branch (in the list identified in step 210), applies the analytical context of the analysis branch to the identified current data analysis step, and provides each instance as an analysis recommendation. In example embodiments, responsive to receiving proposed analysis recommendations from recommendation program 200, client device 110 or 115 can make a selection of an analysis recommendation (via user input to application 114 through user interface 112) for the application to subsequently perform.

In the previously discussed example, recommendation program 200 identified the current data analysis step of application 114 to be “sales data for product X in North America for the date range of March 2012 to June 2012 showing a sharp decline” (in step 202), and a list of analysis branches, which includes an analysis branch of “returns data for product Y in North America for the date range of January 2012 to March 2012 showing a sharp decline,” among a plurality of other analysis branches (as described in step 208). In this example, recommendation program 200 identified the analysis branch of “returns data for product Y in North America for the date range of January 2012 to March 2012 showing a sharp decline” to be included in the most similar analysis branches (step 210). Recommendation program 200 utilizes the analysis context of “product Y, returns, North America, January 2012 to March 2012, sharp decline” to propose an analysis recommendation for the identified current data analysis step of “returns data for product X in North America for the date range of March 2012 to June 2012.” In another example, recommendation program 200 utilizes the analysis context of “product Y, returns, North America, January 2012 to March 2012, sharp decline” to propose an analysis recommendation for the identified current data analysis step of “sales data for product X in North America for the date range of January 2012 to March 2012.” In example embodiments, the proposed analysis recommendations can provide a modification to the identified current data analysis step to assist an individual utilizing application 114 on client device 110 or 115 to perform a data analysis, which is based on analytical context of previously performed analyses of data 136 (i.e., previous analyses 137).

FIG. 3 depicts a block diagram of components of computer 300, which is representative of client devices 110 and 115, and server 130 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computer 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are examples of computer-readable tangible storage devices. A storage device is any piece of hardware that is capable of storing information, such as, data, program code in functional form, and/or other suitable information on a temporary basis and/or permanent basis. In this embodiment, memory 306 includes random access memory (RAM) 314 and cache memory 316. In general, memory 306 can include any suitable volatile or non-volatile computer-readable storage device. Software and data 322 are stored in persistent storage 308 for access and/or execution by processors 304 via one or more memories of memory 306. With respect to client devices 110 and 115, software and data 322 represents application 114. With respect to server 130, software and data 322 represents data 136, previous analyses 137, and recommendation program 200.

In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices. In these examples, communications unit 310 may include one or more network interface cards. Communications unit 310 may provide communications through the use of either or both physical and wireless communications links. Software and data 322 may be downloaded to persistent storage 308 through communications unit 310.

I/O interface(s) 312 allows for input and output of data with other devices that may be connected to computer 300. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data 322 can be stored on such portable computer-readable storage media and can be loaded onto persistent storage 308 via I/O interface(s) 312. I/O interface(s) 312 also can connect to a display 320.

Display 320 provides a mechanism to display data to a user and may be, for example, a computer monitor. Display 320 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-6. (canceled)

7. A computer program product for proposing recommendations in data analysis based on context, including one or more computer-readable storage media and program instructions stored on at least one of the one or more storage media, wherein execution of the program instructions by one or more processors of a computer system causes the one or more processors to carry out the acts of:
determining analytical context of an analysis step currently being performed in a data analysis;
identifying a list of previously performed analysis branches that are similar to the determined analytical context, wherein an analysis branch is a set of analysis steps that corresponds to attributes of an analytical context;
identifying a set of most similar previously performed analysis branches based on a similarity index rating associated with each previously performed analysis branch that is in an analysis tree associated with each previously performed analysis branch in the identified list, wherein an analysis tree is a set of analysis branches that share a common analysis step; and
proposing analysis recommendations for the analysis step currently being performed based on analytical context of the previously performed analysis branches in the identified set.

8. The computer program product in accordance with claim 7,
wherein analytical context is a set of attributes that characterizes an analysis, and
wherein the attributes utilized in the determination and definition of an analytical context include one or more of: name, annotations, data source, concepts, measurements, hierarchies, filters, members, and analysis parameters.

9. The computer program product in accordance with claim 7, wherein the list of previously performed analysis branches that are similar to the determined analytical context are identified utilizing semantic similarity between the determined analytical context of the analysis step currently being performed in the data analysis and previously performed analysis branches.

10. The computer program product in accordance with claim 7, wherein the previously performed analysis branches are stored previously performed sets of steps in data analysis that include parameters utilized to perform the sets of steps in data analysis.

11. The computer program product in accordance with claim 7, wherein program instructions for identifying a set of most similar previously performed analysis branches based on a similarity index rating associated with each previously performed analysis branch that is in an analysis tree associated with each previously performed analysis branch in the identified list further comprises program instructions to carry out the additional acts of:
identifying, for each previously performed analysis branch in the identified list, a stored similarity index associated with every other previously performed analysis branch in the analysis tree associated with the previously performed analysis branch in the identified list of previously performed analysis branches that are similar to the determined analytical context,
wherein the similarity index rating is calculated based on relative distance from an analysis branch to other analysis branches in a multi vector space and stored associated the corresponding previously performed analysis branch, and
wherein a number of previously performed analysis branches in the identified set is based on a user defined configuration.

12. The computer program product in accordance with claim 7, wherein program instructions for proposing analysis recommendations for the analysis step currently being performed based on analytical context of the previously performed analysis branches in the identified set further comprises program instructions to carry out the additional acts of:
determining an analysis recommendation corresponding to each of the previously performed analysis branches in the identified set by applying one or more of the attributes of the analytical context of the previously performed analysis branch to the analysis step currently being performed; and
proposing each of the determined analysis recommendations.

13. A computer system for proposing recommendations in data analysis based on context, the computer system comprising:
one or more computer processors;
one or more computer-readable storage media; and
program instructions stored on the computer-readable storage media for execution by at least one of the one or more processors, the program instructions comprising:
program instructions to determine analytical context of an analysis step currently being performed in a data analysis;
program instructions to identify a list of previously performed analysis branches that are similar to the determined analytical context, wherein an analysis branch is a set of analysis steps that corresponds to attributes of an analytical context;
program instructions to identify a set of most similar previously performed analysis branches based on a similarity index rating associated with each previously performed analysis branch that is in an analysis tree associated with each previously performed analysis branch in the identified list, wherein an analysis tree is a set of analysis branches that share a common analysis step; and
program instructions to propose analysis recommendations for the analysis step currently being performed based on analytical context of the previously performed analysis branches in the identified set.

14. The computer system in accordance with claim 13,
wherein analytical context is a set of attributes that characterizes an analysis, and
wherein the attributes utilized in the determination and definition of an analytical context include one or more of: name, annotations, data source, concepts, measurements, hierarchies, filters, members, and analysis parameters.

15. The computer system in accordance with claim 13, wherein the list of previously performed analysis branches that are similar to the determined analytical context are identified utilizing semantic similarity between the determined analytical context of the analysis step currently being performed in the data analysis and previously performed analysis branches.

16. The computer system in accordance with claim 13, wherein the previously performed analysis branches are stored previously performed sets of steps in data analysis that include parameters utilized to perform the sets of steps in data analysis.

17. The computer system in accordance with claim 13, wherein the program instructions to identify a set of most similar previously performed analysis branches based on a similarity index rating associated with each previously performed analysis branch that is in an analysis tree associated with each previously performed analysis branch in the identified list, further comprise program instructions to:
identify, for each previously performed analysis branch in the identified list, a stored similarity index associated with every other previously performed analysis branch in the analysis tree associated with the previously performed analysis branch in the identified list of previously performed analysis branches that are similar to the determined analytical context,
wherein the similarity index rating is calculated based on relative distance from an analysis branch to other analysis branches in a multi vector space and stored associated the corresponding previously performed analysis branch, and
wherein a number of previously performed analysis branches in the identified set is based on a user defined configuration.

18. The computer system in accordance with claim 13, wherein the program instructions to propose analysis recommendations for the analysis step currently being performed based on analytical context of the previously performed analysis branches in the identified set, further comprise program instructions to:
determine an analysis recommendation corresponding to each of the previously performed analysis branches in the identified set by applying one or more of the attributes of the analytical context of the previously performed analysis branch to the analysis step currently being performed; and
propose each of the determined analysis recommendations.
